(19) United States
(12) Patent Application Publication
(10) Pub. No.: US 2021/0060762 A1
(43) Pub. Date: Mar. 4, 2021

(54) MASTER-SLAVE SYSTEM, OPERATION APPARATUS, AND ROBOT APPARATUS

(71) Applicant: SONY CORPORATION, TOKYO (JP)

(72) Inventor: KAZUO HONGO, CHIBA (JP)

(21) Appl. No.: 16/961,593

(22) PCT Filed: Dec. 18, 2018
(86) PCT No.: PCT/JP2018/046667

§ 371 Date: Jul. 10, 2020

(30) Foreign Application Priority Data
Jan. 30, 2018 (JP) 2018-013207

(51) Int. Cl. B25J 3/02; B25J 3/04

(52) U.S. Cl. CPC B25J 3/02; B25J 3/04

(57) ABSTRACT

Provided is a master-slave system that causes no unintended operation. A master-slave system includes: a master device having a first link structure; a slave device having a second link structure similar to the first link structure; and a connecting portion that mechanically connects corresponding links of the first link structure and the second link structure so that the corresponding links have the same angle. The first link structure and the second link structure include respective similar parallel links. In addition, the connecting portion connects corresponding links provided at proximal ends of the first link structure and the second link structure to form a four-bar linkage.

### TECHNICAL FIELD

The technology disclosed in this specification relates to a master-slave system, an operation apparatus, and a robot apparatus.

### BACKGROUND ART

In recent years, a master-slave mechanism including a master device operated by a person and a slave device that operates on the basis of output from the master device has been proposed as a robot for realizing precision work and heavy work that is difficult for a human body.

In particular, a haptic master-slave mechanism capable of feeding back force received by the slave device to the master device has attracted great attention (for example, see Patent Document 1). In such a master-slave mechanism, force applied to one device is detected by a force sensor such as a torque sensor, and a detection result is output to the other device, and then the other device operates on the basis of the detection result.

### CITATION LIST

### Patent Document

Patent Document 1: Japanese Patent No. 5212797

### SUMMARY OF THE INVENTION

### Problems to be Solved by the Invention

However, there is a risk that a master device or a slave device may perform unstable operation or unintended operation due to electrical or control factors such as a failure or malfunction of a force sensor.

An object of the technology disclosed in this specification is to provide a master-slave system, an operation apparatus, and a robot apparatus that reduce a risk of a master device or a slave device performing unintended operation.

### Solutions to Problems

The technology disclosed in this specification has been made in view of the above problems, and the first aspect thereof is

a master-slave system including:

a master device having a first link structure;

a slave device having a second link structure similar to the first link structure; and

a connecting portion that mechanically connects corresponding links of the first link structure and the second link structure so that the corresponding links have the same angle.

Further, the second aspect of the technology disclosed in this specification is

an operation apparatus for operating a robot apparatus, the operation apparatus including:

a first link structure; and

a connecting portion that mechanically connects corresponding links of a second link structure similar to the first link structure so that the corresponding links have the same angle, the second link structure being included in the robot apparatus.

Further, the third aspect of the technology disclosed in this specification is

a robot apparatus that operates following operation of an operation apparatus, the robot apparatus including:

a second link structure; and

a connecting portion that mechanically connects corresponding links of a first link structure similar to the second link structure so that the corresponding links have the same angle, the first link structure being included in the operation apparatus.

### Effects of the Invention

The technology disclosed in this specification can provide a master-slave system, an operation apparatus, and a robot apparatus that reduce a risk of a master device or a slave device performing unintended operation.

Note that effects described herein are merely examples, and effects of the present invention are not limited thereto. Further, the present invention may also have additional effects in addition to the above-described effects.

Other objects, features, and advantages of the technology disclosed herein will be apparent from more detailed description based on embodiments described below and the accompanying drawings.

### BRIEF DESCRIPTION OF DRAWINGS

FIG. 1 schematically illustrates a configuration example of a master-slave system 1 to which the technology disclosed in this specification is applied.

FIG. 2 illustrates a master device 2100 and a slave device 2200, each of which is formed by a delta-type parallel link.

FIG. 3 illustrates a master device 3100 and a slave device 3200, each of which is formed by a delta-type parallel link.

FIG. 4 illustrates a master-slave system 4 to which similar parallel link structures are applied.

FIG. 5 illustrates a state in which the master-slave system 4 is viewed from above.

FIG. 6 illustrates a master-slave system 6 to which similar parallel link structures are applied.

FIG. 7 illustrates a state in which a master-slave system 6 is viewed from above.

FIG. 8 illustrates an operation example of the master-slave system 1.

FIG. 9 illustrates a modification example of the master-slave system 6 of FIG. 6.

FIG. 10 illustrates another modification example of the master-slave system 6 of FIG. 6.

FIG. 11 illustrates a modification example of the master-slave system 6 of FIG. 10.

FIG. 12 illustrates a state in which a modification example of the master-slave system 6 of FIGS. 6 and 7 is viewed from above.

FIG. 13 illustrates an example in which attenuators are arranged in a master device 4100 of the master-slave system 4 of FIG. 5.

FIG. 14 illustrates an example in which an attenuator is arranged in a master device 4100 of the master-slave system 4 of FIG. 4.

FIG. 15 illustrates a configuration example of a mechanical bilateral control system 15.

### MODE FOR CARRYING OUT THE INVENTION

Hereinafter, embodiments of the technology disclosed in this specification will be described in detail with reference to the drawings.

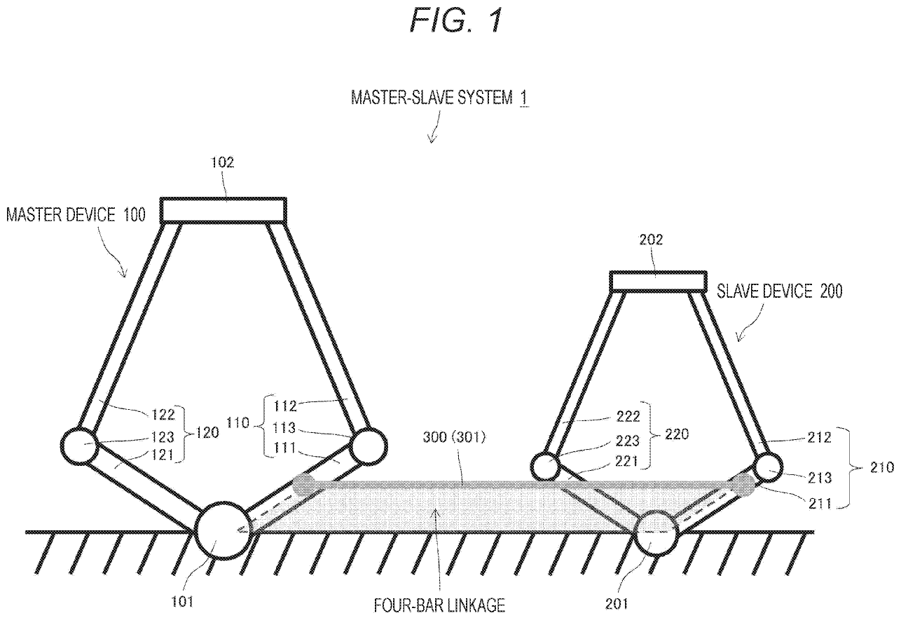

FIG. 1 schematically illustrates a configuration example of a master-slave system 1 to which the technology disclosed in this specification is applied. Hereinafter, description will be made with reference to FIG. 1. The master-slave system 1 includes a master device 100 having a parallel link structure, a slave device 200 having a parallel link structure similar to that of the master device 100, and a connecting portion 300 that mechanically connects the corresponding links of the master device 100 and the slave device 200.

The parallel link structure is a structure in which a plurality of link mechanisms is combined in parallel and is operated in parallel to operate a movable portion. Further, each link mechanism is a mechanism including a link portion serving as a connecting member and a joint serving as a movable member.

Both the parallel link structures of the master device 100 and the slave device 200 are assumed to have three or more degrees of freedom. In FIG. 1, for simplicity, each of the parallel link structures of the master device 100 and the slave device 200 includes only two link portions 110 and 120 or 210 and 220, but actually has three or more link portions. A parallel link structure including three link portions is also referred to as “delta type”. In a case of the delta type, the link portions 110, 120, . . . are arranged at intervals of approximately 120 degrees about a fixed portion 101.

The connecting portion 300 includes a plurality of connecting links for mechanically connecting the corresponding links of the master device 100 and the slave device 200. In order to prevent the drawing from being complicated, FIG. 1 illustrates only a connecting link 301 that mechanically connects the link portion 110 of the master device 100 and the corresponding link portion 210 of the slave device 200. However, the connecting portion actually includes connecting links that mechanically connect the link portion 120 and the link portion 220 and other corresponding link structures (not illustrated). Note that the connecting link 301 has high rigidity and transmits operation between the link portion 110 and the link portion 210 without delay by using force generated by a constraint condition caused by a mechanical structure. However, in a case where the slave device 200 is remotely controlled by the master device 100 or in other cases, wire tension, air pressure, water pressure, or the like is also assumed to be used for the connecting portion 300. The other connecting links (not illustrated) is provided similarly.

The parallel link structure of the master device 100 and the parallel link structure of the slave device 200 are similar. In FIG. 1, the parallel link structure of the master device 100 is illustrated larger and the parallel link structure of the slave device 200 is illustrated smaller. However, a size relationship therebetween may be reversed. That is, the parallel link structure of the slave device 200 may be larger than the parallel link structure of the master device 100. Further, similar shapes may be congruent.

With a mechanism described later, the connecting portion 300 mechanically connects the corresponding link portions of the parallel link structures of the master device 100 and the slave device 200 so that the corresponding link portions have the same angle. Therefore, operation of the master device 100 and operation of the slave device 200 can be made similar. For example, in a case where a size ratio between the master device 100 and the slave device 200 is N:1, displacement of the slave device 200 is 1/N of displacement of the master device 100 in a three-dimensional space (a displacement vector faces the same direction, but magnitude of the vector is 1/N). When the size ratio is increased, large operation in the master device 100 can be converted into smaller operation, and the smaller operation can be reproduced in the slave device 200. Therefore, the master-slave system is applicable to a fine working apparatus that performs work on a small target object such as a cell.

Further, in a case where the size ratio between the master device 100 and the slave device 200 is 1:N, displacement of the slave device 200 is N times as large as displacement of the master device 100 in the three-dimensional space (the displacement vector faces the same direction, but the magnitude of the vector is twice). That is, because the master device 100 and the slave device 200 include the similar parallel link structures, it is possible to transmit operation of the master device 100 to the slave device 200 via the connecting portion 300 and change magnification of the operation.

First, the parallel link structure of the master device 100 will be described.

One end of the link portion 110 is rotatably supported by the fixed portion 101, and the other end thereof is connected to a movable portion 102. The link portion 110 includes a drive link 111 whose one end (proximal end) is rotatably supported by the fixed portion 101 and a driven link 112 that is rotatably connected in series to the other end of the drive link 111 via a joint 113. The movable portion 102 is attached to the other end (distal end) of the driven link 112. The joint 113 connects the drive link 111 and the driven link 112 so as to be operable with one or more rotational degrees of freedom about a rotational axis orthogonal to a longitudinal direction of the drive link 111. Further, the joint 113 may connect the drive link 111 and the driven link 112 so as to be operable even with a rotational degree of freedom about a rotational axis in the longitudinal direction of the drive link 111. Note that an actuator including, for example, a servomotor and the like may be provided at one end of the drive link 111 so that the link portion 110 is rotationally driven with respect to the fixed portion 101. For example, the actuator in which an encoder that measures a rotation angle of an output shaft of a motor and a torque sensor that detects a torque acting on the output shaft of the motor are integrated with a servomotor is used. Further, self-weight compensation or gravity compensation may be performed according to the detected torque.

Similarly, another link portion 120 includes a drive link 121 and a driven link 122 that is connected in series to the drive link 121 via a joint 123, and is rotatably supported by the fixed portion 101 at one end (proximal end) of the drive link 121. The movable portion 102 is attached to the other end (distal end) of the driven link 122. The joint 123 connects the drive link 121 and the driven link 122 so as to be operable with one or more rotational degree of freedom about a rotational axis orthogonal to a longitudinal direction of the drive link 121. Further, the joint 123 may connect the drive link 121 and the driven link 122 so as to be operable even with a rotational degree of freedom about a rotational axis in the longitudinal direction of the drive link 121. Note that an actuator including, for example, a servomotor and the like may be provided at one end of the drive link 121 so that the link portion 120 is rotationally driven with respect to the fixed portion 101.

Although not illustrated in FIG. 1, the master device 100 is assumed to include one or more link portions in addition to the link portions 110 and 120, i.e., include three or more link portions in total. Further, similarly, each of the one or more link portions (not illustrated) includes a drive link and a driven link connected in series, a proximal end of the drive link is rotatably supported by the fixed portion 101, and the movable portion 102 is attached to a distal end of the driven link.

For example, when an operator of the master device 100 moves the movable portion 102 relative to the fixed portion 101 in the three-dimensional space, the driven links 112, 122, . . . of the respective link portions 110 and 120 rotate with respect to the drive links 111, 121, . . . , and the drive links 111, 121, . . . rotate with respect to the fixed portion 101. Alternatively, when the drive links 111, 121, . . . of the respective link portions 110, 120, . . . are driven by respective actuators, the movable portion 102 can be moved relative to the fixed portion 101 in the three-dimensional space. A user interface (not illustrated) used by the operator for input is mounted on the movable portion 102.

The parallel link structure of the slave device 200 is similar to the parallel link structure of the master device 100.

One end of the link portion 210 is rotatably supported by a fixed portion 201, and the other end thereof is connected to a movable portion 202. The link portion 210 includes a drive link 211 whose one end (proximal end) is rotatably supported by the fixed portion 201 and a driven link 212 that is rotatably connected in series to the other end of the drive link 211 via a joint 213. The movable portion 202 is attached to the other end (distal end) of the driven link 212. Note that an actuator including, for example, a servomotor and the like may be provided at one end of the drive link 211 so that the link portion 210 is rotationally driven with respect to the fixed portion 201 (same as above).

Similarly, another link portion 220 includes a drive link 221 and a driven link 222 that is connected in series to the drive link 221 via a joint 223, and is rotatably supported by the fixed portion 201 at one end (proximal end) of the drive link 221. The movable portion 202 is attached to the other end (distal end) of the driven link 222. An actuator including, for example, a servomotor and the like may be provided at one end of the drive link 221 so that the link portion 220 is rotationally driven with respect to the fixed portion 201 (same as above).

Further, similarly, each of the one or more link portions (not illustrated) includes a drive link and a driven link connected in series, and a proximal end of the drive link is rotatably supported by the fixed portion 201, and the movable portion 202 is attached to a distal end of the driven link.

The link portion 110 of the master device 100 and the corresponding link portion 210 of the slave device 200 are mechanically connected by the connecting link 301 included in the connecting portion 300, and the link portion 110 and the link portion 210 operate so as to have the same angle with respect to the fixed portions 101 and 201, respectively.

Herein, relative positions of the fixed portion 101 of the master device 100 and the fixed portion 201 of the slave device 200 are fixed. In addition, the drive link 111 of the link portion 110 and the drive link 211 of the link portion 210 are connected by the connecting link 301 to form a four-bar linkage in which connection between the fixed portion 101 and the fixed portion 201 serves as a “fixed link”, the connecting link 301 serves as a “coupler link” that is parallel to the fixed link, the drive link 111 serves as a “driver link”, and the drive link 211 serves as a “follower link”. Thus, when the drive link 111 swings about the fixed portion 101, the other drive link 211 also swings about the fixed portion 201 by the same angle. Note that the above “parallel” relationship between the fixed link and the coupler link in the four-bar linkage does not need to be strictly parallel as long as the four-bar linkage has the same effect (i.e., the driven link swings following the driver link) (the same applies hereinafter).

Further, similarly, the link portion 120 of the master device 100 and the corresponding link portion 220 of the slave device 200 are mechanically connected by another connecting link (not illustrated) included in the connecting portion 300 so as to form a four-bar linkage, and the link portion 120 and the link portion 220 operate so as to have the same angle with respect to the fixed portions 101 and 201. Furthermore, similarly, the third or subsequent link portions (not illustrated) of the master device 100 and the slave device 200 are mechanically connected by another connecting link (not illustrated) included in the connecting portion 300 so as to form a four-bar linkage so that the link portions have the same angle with respect to the fixed portions 101 and 201.

When the operator of the master device 100 moves the movable portion 102 relative to the fixed portion 101 in the three-dimensional space, the driven links 112, 122, . . . of the respective link portions 110 and 120 rotate with respect to the drive links 111, 121, . . . , and the drive links 111, 121, . . . rotate with respect to the fixed portion 101. Meanwhile, in the slave device 200, the drive links 211, 221, . . . of the respective link portions 210 and 220 are constrained by the above four-bar linkage including the connecting portion 300, and operate so as to have the same angles as those of the drive links 111, 121, . . . of the master device 100, respectively. Further, the driven links 212, 222, . . . operate following the drive links 211, 221, . . . , respectively, and the movable portion 202 moves relative to the fixed portion 201 in the three-dimensional space. For example, a medical instrument (not illustrated) such as a surgical tool including forceps and a cutting instrument and a medical observation device including a microscope, an endoscope, and the like (a rigid endoscope such as a laparoscope or an arthroscope and a flexible endoscope such as a gastrointestinal endoscope or a bronchoscope) is mounted on the movable portion 202.

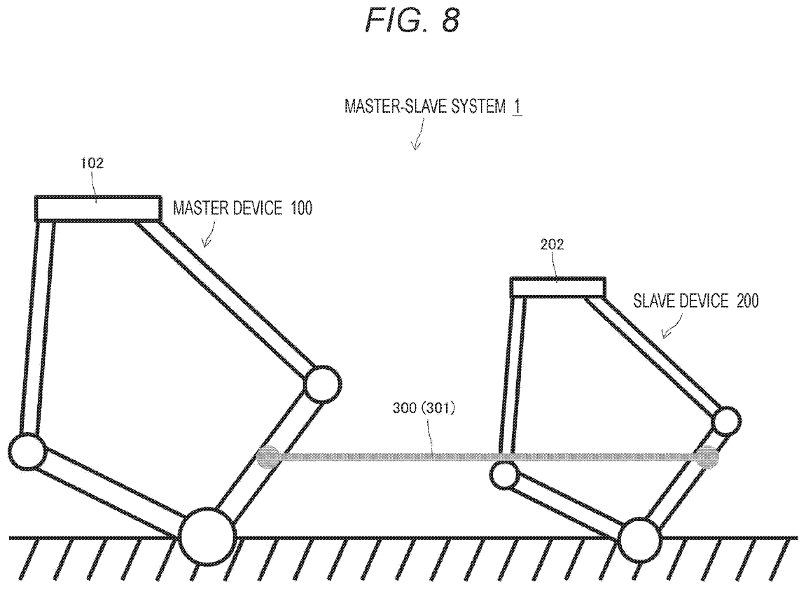

Because the corresponding link portions are constrained at the same angle, operation of the movable portion 202 with respect to the fixed portion 201 in the slave device 200 is similar to operation of the movable portion 102 with respect to the fixed portion 101 in the master device 100. FIG. 8 illustrates a state in which the movable portion 202 of the slave device 200 moves in the three-dimensional space in a manner similar to operation of the movable portion 102 of the master device 100. Hereinafter, description will be made with reference to FIG. 8.

When a scale of the slave device 200 is increased with respect to the master device 100, large operation in the master device 100 can be converted into smaller operation, and the smaller operation can be reproduced in the slave device 200. Therefore, the master-slave system 1 is applicable to a fine working apparatus that performs work on a small target object such as a cell. For example, the operator can perform fine work by operating the movable portion 102 of the master device 100 while observing an enlarged video image of the vicinity of the movable portion 202 of the slave device 200.

When the parallel link is applied to the master device 100 and the slave device 200, it is possible to form lightweight tips (the movable portions 102 and 202) and make inertia small during operation. Further, three or more degrees of freedom can be easily realized only by connecting the corresponding link portions of the master device 100 and the slave device 200 on the proximal end side by a four-bar linkage.

Note that, in FIG. 1, for convenience of description, the proximal end of each of the link portions 110, 120, . . . included in the parallel link structure of the master device 100 is supported by the single fixed portion 101, and the rotational axes of the respective link portions pass through the same point. However, in practice, it is difficult to cause the rotational axes of the respective link portions 110, 120, . . . to pass through the same point due to the volume of components such as bearings that support the rotational axes of the respective link portions 110, 120, . . . , and the like. In reality, the rotational axes on the proximal end side of all the link portions are separated at a certain distance or more (in a case where a driving actuator such as a motor is arranged in each link portion, it is more difficult to cause the rotational axes to pass through the same point). The parallel link structure of the slave device 200 is provided similarly.

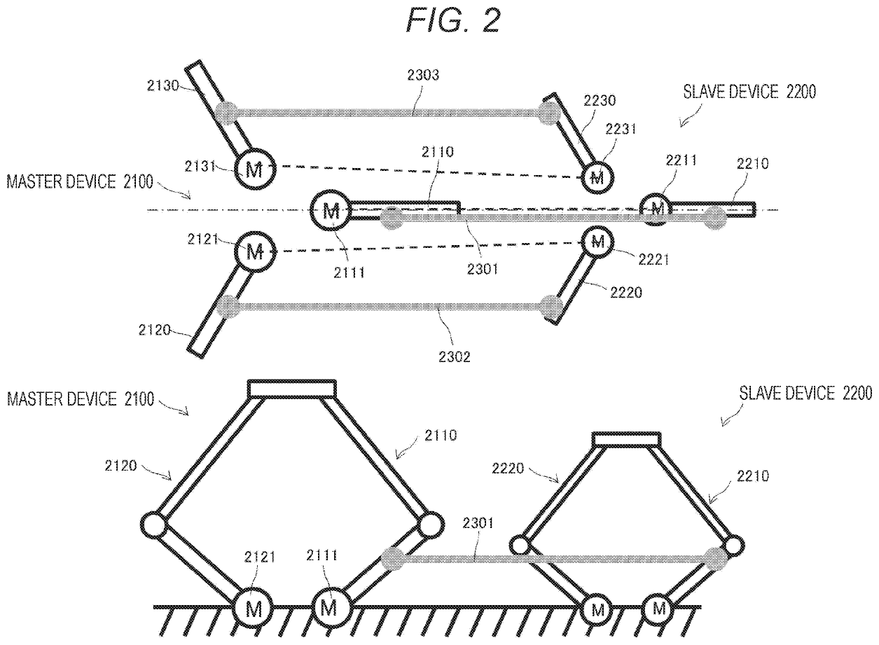

FIG. 2 illustrates states in which a master device 2100 formed by a delta-type parallel link and a slave device 2200 formed by a delta-type parallel link similar to that of the master device 2100 are viewed from above and from a side. Hereinafter, description will be made with reference to FIG. 2.

Rotational axes 2111, 2121, and 2131 on the proximal end side of respective link portions 2110, 2120, and 2130 forming the delta-type parallel link of the master device 2100 are separated from each other to form a triangle. In practice, it is difficult to cause the rotational axes of the respective link portions 2110, 2120, and 2130 to pass through the same point due to the volume of the bearings supporting the rotational axes 2111, 2121, and 2131 of the respective link portions 2110, 2120, and 2130, the volume of actuators such as motors (M), and the like. Similarly, rotational axes 2211, 2221, and 2231 of respective link portions 2210, 2220, and 2230 forming the delta-type parallel link of the slave device 2200 are also separated from each other to form a triangle. The triangle of the master device 2100 and the triangle of the slave device 2200 are similar.

Herein, even if the link portion 2110 and the link portion 2210 are connected by a connecting link 2301 serving as the “coupler link”, the connecting link 2301 is not parallel to the “fixed link” that is a segment drawn by a dotted line connecting the rotational axis 2111 of the link portion 2110 and the rotational axis 2211 of the link portion 2210. Therefore, such a four-bar linkage cannot accurately transmit a displacement direction so that the link portion 2210 is operated at the same angle as the link portion 2110.

Further, even if the link portion 2120 and the link portion 2220 are connected by a connecting link 2302 serving as the “coupler link”, the connecting link 2302 is not parallel to the “fixed link” that is a segment drawn by a dotted line connecting the rotational axis 2121 of the link portion 2120 and the rotational axis 2221 of the link portion 2220. Thus, it is impossible to accurately transmit the displacement direction so that the link portion 2220 is operated at the same angle as the link portion 2210. A case where the link portion 2130 and the link portion 2230 are connected by a connecting link 2303 serving as the “coupler link” is also similar to this case.

In short, even if the link portions of the master device 2100 and the slave device 2200 formed by the similar delta-type parallel links are mechanically connected by respective four-bar linkages, it is impossible to accurately transmit the displacement direction because the rotational axes of the respective link portions in each delta-type parallel link do not pass through the same point. A parallel link structure other than the delta-type one, such as a hexagon-type one, is provided similarly.

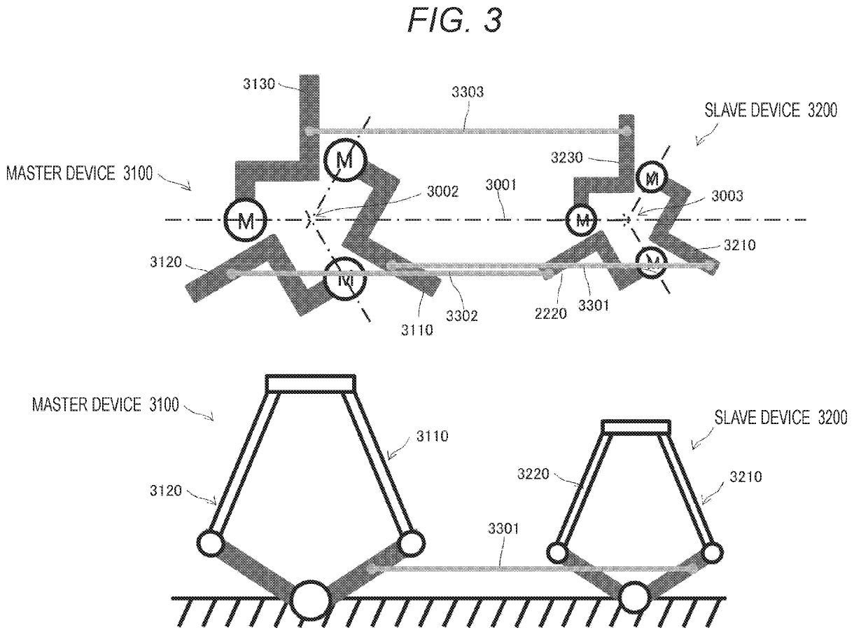

FIG. 3 illustrates states in which a master device 3100 formed by a delta-type parallel link and a slave device 3200 formed by a delta-type parallel link similar to that of the master device 3100 according to another configuration example are viewed from above and from a side. Hereinafter, description will be made with reference to FIG. 3.

Each of link portions 3110, 3120, and 3130 forming the delta-type parallel link of the master device 3100 has a crank shape. Therefore, component modules (M) such as bearings that rotatably support the proximal end side of the respective link portions 3110, 3120, and 3130 are arranged separately from the rotational axes of the respective link portions 3110, 3120, and 3130. However, the rotational axes of the respective link portions 3110, 3120, and 3130 pass through the same point 3002.

Further, the delta-type parallel link of the slave device 3200 is similar to that of the master device 3100, and each of link portions 3210, 3220, and 3230 has a crank shape on the proximal end side. Thus, the rotational axes thereof pass through the same point 3003.

Therefore, when a straight line 3001 (drawn by an alternate long and short dash line) connecting the same point 3002 through which the rotational axes of the respective link portions of the master device 3100 pass and the same point 3003 through which the rotational axes of the respective link portions of the slave device 3200 pass serves as the “fixed link”, and the link portion 3110 and the link portion 3210, the link portion 3120 and the link portion 3220, and the link portion 3130 and the link portion 3230 are connected by the respective connecting links 3301, 3302, and 3303 serving as the “coupler link” that is parallel to the above fixed link, the corresponding link portions of the master device 3100 and the slave device 3200 can be constrained by the four-bar linkage and be operated at the same angle. Note that the connecting links 3301 to 3303 have high rigidity and transmit operation between the master device 3100 and the slave device 3200 without delay by using force generated by a constraint condition caused by a mechanical structure. However, in a case where the master device 3100 remotely controls the slave device 3200 or in other cases, wire tension, air pressure, water pressure, or the like is also assumed to be used to transmit operation, instead of the mechanical connecting links 3301 to 3303.

Therefore, as illustrated in FIG. 3, when the master device 3100 and the slave device 3200 having similar shapes are formed by using the delta-type parallel links that are configured so that the rotational axes of the respective link portions match, it is possible to accurately transmit the displacement direction to the slave device 3200 from the master device 3100.

Note that, although not illustrated or described in detail, also in a case where the master-slave system is formed by a parallel link structure having four or more axes, such as the hexagon-type one instead of the delta-type one, the parallel link structure is similarly configured so that rotational axes of respective link portions pass through the same point. Thus, it is possible to connect the corresponding link portions of the master device and the slave device by the four-bar linkage and accurately transmit the displacement direction.

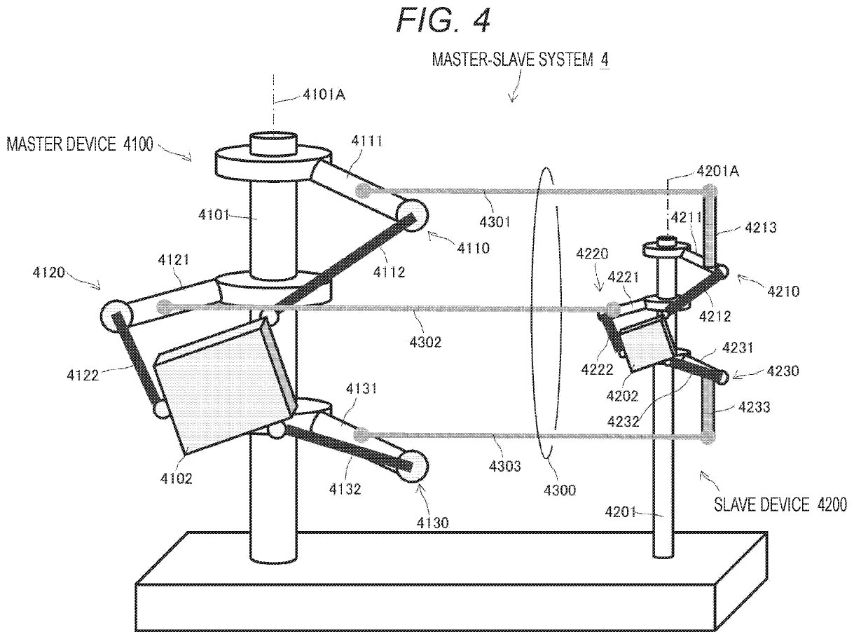

FIG. 4 illustrates a master-slave system 4 to which other parallel link structures are applied. The master-slave system 4 includes a master device 4100 having a parallel link structure, a slave device 4200 having a parallel link structure similar to that of the master device 4100, and a connecting portion 4300 that mechanically connects the corresponding links of the master device 4100 and the slave device 4200. Hereinafter, description will be made with reference to FIG. 4.

The parallel link structure of the master device 4100 and the parallel link structure of the slave device 4200 are similar. In FIG. 4, the parallel link structure of the master device 4100 is illustrated larger and the parallel link structure of the slave device 4200 is illustrated smaller. However, a size relationship therebetween may be reversed. That is, the parallel link structure of the slave device 4200 may be larger than the parallel link structure of the master device 4100.

In the parallel link of the master device 4100, three link portions 4110, 4120, and 4130 are rotatably supported by a fixed portion 4101 at respective one ends (proximal ends) about a common axis 4101A.

The link portion 4110 includes a drive link 4111 connected to the fixed portion 4101 and a driven link 4112 rotatably connected in series to the other end of the drive link 4111 via a joint. Further, the link portion 4120 includes a drive link 4121 connected to the fixed portion 4101 and a driven link 4122 rotatably connected in series to the other end of the drive link 4121 via a joint. Further, the link portion 4130 includes a drive link 4131 connected to the fixed portion 4101 and a driven link 4132 rotatably connected in series to the other end of the drive link 4131 via a joint. Each of the drive links 4111, 4121, and 4131 is a freely rotatable link having one degree of freedom about the common axis 4101A. Further, each of the driven links 4112, 4122, and 4132 has two degrees of freedom, that is, a rotational degree of freedom about a rotational axis in a longitudinal direction of each of the drive links 4111, 4121, and 4131 and a rotational degree of freedom about a rotational axis orthogonal to the longitudinal direction. Therefore, each of the link portions 4110, 4120, and 4130 has at least three degrees of freedom. Each of the link portions 4110, 4120, and 4130 may have four or more degrees of freedom. In addition, a movable portion 4102 is supported by the other end (distal end) of each of the driven links 4112, 4122, and 4132.

Intervals in the longitudinal (common axis 4101A) direction in which the link portions 4110, 4120, and 4130 are attached to the fixed portion 4101 are arbitrary. Further, the number of link portions provided in the parallel link is not limited to three in FIG. 4, and four or more link portions may be provided. However, the master device 4100 and the slave device 4200 are similar, and both have the same number of link portions.

For example, when the operator of the master device 4100 moves the movable portion 4102 relative to the fixed portion 4101 in the three-dimensional space, the driven links 4112, 4122, and 4132 of the respective link portions 4110, 4120, and 4130 rotate with respect to the drive links 4111, 4121, and 4131, and the drive links 4111, 4121, and 4131 rotate about the common axis 4101A. Alternatively, when the drive links 4111, 4121, and 4131 of the respective link portions 4110, 4120, and 4130 are rotatably driven about the common axis 4101A by respective actuators, the movable portion 4102 can be moved relative to the fixed portion 4101 in the three-dimensional space. A user interface (not illustrated) used by the operator for input is mounted on the movable portion 4102.

The parallel link structure of the slave device 4200 is similar to the parallel link structure of the master device 4100. In the parallel link of the slave device 4200, three link portions 4210, 4220, and 4230 are rotatably supported at respective one ends (proximal ends) by a fixed portion 4201 about a common axis 4201A.

The link portion 4210 includes a drive link 4211 connected to the fixed portion 4201 and a driven link 4212 rotatably connected in series to the other end of the drive link 4211 via a joint. Further, the link portion 4220 includes a drive link 4221 connected to the fixed portion 4201 and a driven link 4222 rotatably connected in series to the other end of the drive link 4221 via a joint. Further, the link portion 4230 includes a drive link 4231 connected to the fixed portion 4201 and a driven link 4232 rotatably connected in series to the other end of the drive link 4231 via a joint. Each of the drive links 4211, 4221, and 4231 is a freely rotatable link having one degree of freedom about the common axis 4201A. Further, each of the driven links 4212, 4222, and 4232 has two degrees of freedom, that is, a rotational degree of freedom about a rotational axis in a longitudinal direction of each of the drive links 4211, 4221, and 4231 and a rotational degree of freedom about a rotational axis orthogonal to the longitudinal direction. Therefore, as in the master device 4100, each of the link portions 4210, 4220, and 4230 has at least three degrees of freedom. Each of the link portions 4210, 4220, and 4230 may have four or more degrees of freedom. Intervals in the longitudinal (common axis 4201A) direction in which the link portions 4210, 4220, and 4230 are attached to the fixed portion 4201 correspond to the intervals in the master device 4100. In addition, a movable portion 4202 is supported by the other end (distal end) of each of the driven links 4212, 4222, and 4232.

The link portion 4110 of the master device 4100 and the corresponding link portion 4210 of the slave device 4200 are mechanically connected by the connecting link 4301 included in the connecting portion 4300, and the link portion 4110 and the link portion 4210 rotatably operate about the common axes 4101A and 4201A, respectively.

Herein, the common axis 4101A of the master device 4100 and the common axis 4201A of the slave device 4200 are arranged in parallel, and relative positions thereof are fixed. In addition, the drive link 4111 of the link portion 4110 and the drive link 4211 of the link portion 4210 are connected by the connecting link 4301 to form a four-bar linkage in which connection between the common axis 4101A and the common axis 4201A serves as the “fixed link”, the connecting link 4301 serves as the “coupler link” that is parallel to the fixed link, the drive link 4111 serves as the “driver link”, and the drive link 4211 serves as the “follower link”. Thus, when the drive link 4111 swings about the common axis 4101A, the other drive link 4211 also swings about the common axis 4201A by the same angle.

Further, similarly, the link portion 4120 of the master device 4100 and the corresponding link portion 4220 of the slave device 4200 are mechanically connected by another connecting link 4302 included in the connecting portion 4300 so as to form a four-bar linkage, and the link portions 4120 and 4220 operate so as to have the same angle with respect to the common axes 4101A and 4201A. Furthermore, similarly, the link portion 4130 of the master device 4100 and the corresponding link portion 4230 of the slave device 4200 are mechanically connected by another connecting link 4303 included in the connecting portion 4300 so as to form a four-bar linkage so that the link portions have the same angle with respect to the common axes 4101A and 4201A. Note that the connecting links 4301 to 4303 have high rigidity and transmit operation between the master device 4100 and the slave device 4200 without delay by using force generated by a constraint condition caused by a mechanical structure. However, in a case where the master device 4100 remotely controls the slave device 4200 or in other cases, wire tension, air pressure, water pressure, or the like is also assumed to be used to transmit operation, instead of the mechanical connecting links 4301 to 4303.

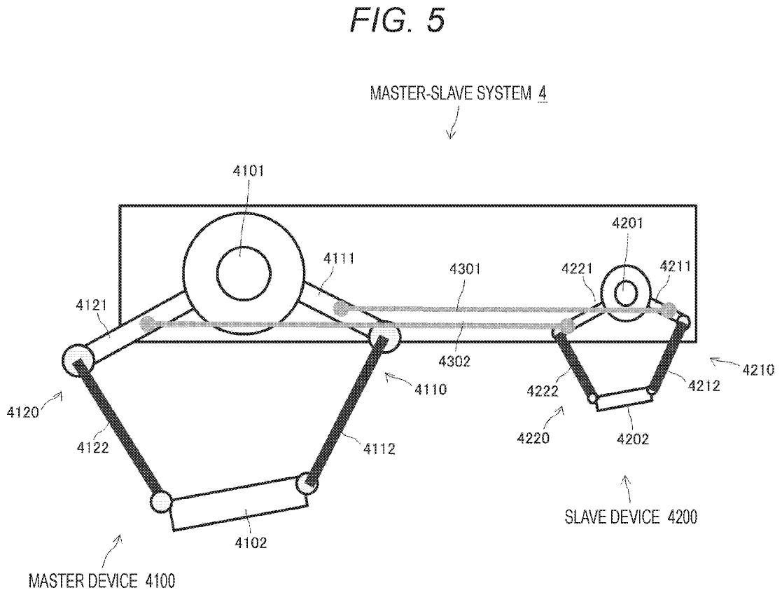

FIG. 5 illustrates a state in which the master-slave system 4 is viewed from above. It should be understood that each of the link portions 4110, . . . of the master device 4100 and each of the corresponding link portions 4210, . . . of the slave device 4200 are connected by the connecting links 4301, . . . to form each four-bar linkage. Hereinafter, description will be made with reference to FIGS. 4 and 5.

In the parallel link structures of FIGS. 4 and 5, one ends (proximal ends) of all the link portions are rotatably supported about a single common axis, unlike a parallel link structure in which one end (proximal end) of each link portion is arranged on a plane surface, such as the delta-type parallel link. In other words, the rotational axes of the respective link portions pass through the same point. Thus, the corresponding link portions of the master device and the slave device that are similar to each other are connected by a connecting link to form a four-bar linkage and are therefore easily constrained at the same angle. For example, the four-bar linkage can be easily incorporated and the number of link portions can be easily increased, without making improvements such as forming the link portions into a crank shape as in the configuration example of FIG. 3.

Note that, because the master device 4100 and the slave device 4200 are similar, vertical positions of the corresponding link portions may not match in some cases. When the link portions whose vertical positions do not match are connected by the connecting links 4301 and 4303, differences between vertical positions of the link portions 4110 and 4210 and 4130 and 4230 may be interpolated by connecting the link portions via spacers 4213 and 4233.

When the operator of the master device 4100 moves the movable portion 4102 relative to the fixed portion 4101 in the three-dimensional space, the driven links 4112, 4122, and 4132 of the respective link portions 4110, 4120, and 4130 rotate with respect to the drive links 4111, 4121, and 4131, and the drive links 4111, 4121, and 4131 rotate about the common axis 4101A. Meanwhile, in the slave device 4200, the drive links 4211, 4221, and 4231 of the respective link portions 4210, 4220, and 4230 are constrained by the above four-bar linkage, and rotatably operate about the common axis 4201A so as to have the same angles as those of the drive links 4111, 4121, and 4131 of the master device 4100, respectively. Further, the driven links 4212, 4222, and 4232 operate following the drive links 4211, 4221, and 4231, respectively, and the movable portion 4202 moves relative to the fixed portion 4201 in the three-dimensional space. A medical instrument such as forceps (described above), for example, is mounted on the movable portion 4202.

In the master device 4100, the link portions 4110, 4120, and 4130 are arranged on the fixed portion 4101 at vertically shifted positions, and, correspondingly, also in the slave device 4200, the link portions 4210, 4220, and 4230 are arranged on the fixed portion 4201 at vertically shifted positions. Thus, the four-bar linkages do not collide with each other while the movable portions 4102 and 4202 are being moved in the three-dimensional space as described above.

Because the corresponding link portions of the master device 4100 and the slave device 4200 are constrained at the same angle by the four-bar linkage, operation of the movable portion 4202 with respect to the fixed portion 4201 in the slave device 4200 is similar to operation of the movable portion 4102 with respect to the fixed portion 4101 in the master device 4100. When a scale of the slave device 4200 is increased with respect to the master device 4100, large operation in the master device 4100 can be converted into smaller operation, and the smaller operation can be reproduced in the slave device 4200. For example, in a case where the slave device 4200 formed at the scale of 1/N of the master device 4100 is connected by a four-bar linkage, operation of the master device 4100 by the operator can be reproduced in the slave device 4200 with a 1/N movement.

When the parallel link is applied to the master device 4100 and the slave device 4200, it is possible to form lightweight tips (the movable portions 4102 and 4202) and make inertia small during operation. Further, three or more degrees of freedom can be easily realized only by connecting the corresponding link portions of the master device 4100 and the slave device 4200 on the proximal end side by a four-bar linkage. Further, when a parallel link structure in which all link portions have a rotational degree of freedom about a common axis at proximal ends is applied instead of the delta-type parallel link, it is possible to form a four-bar linkage by using ball bearings having a simple configuration and less backlash instead of spherical joints.

Note that the reason why a four-bar linkage is formed by movable links on the proximal end side of the corresponding link portions instead of driven links on the distal end side thereof is that the corresponding links on the distal end side are not parallel to each other in many cases and the four-bar linkage having simple configuration and less backlash cannot be used.

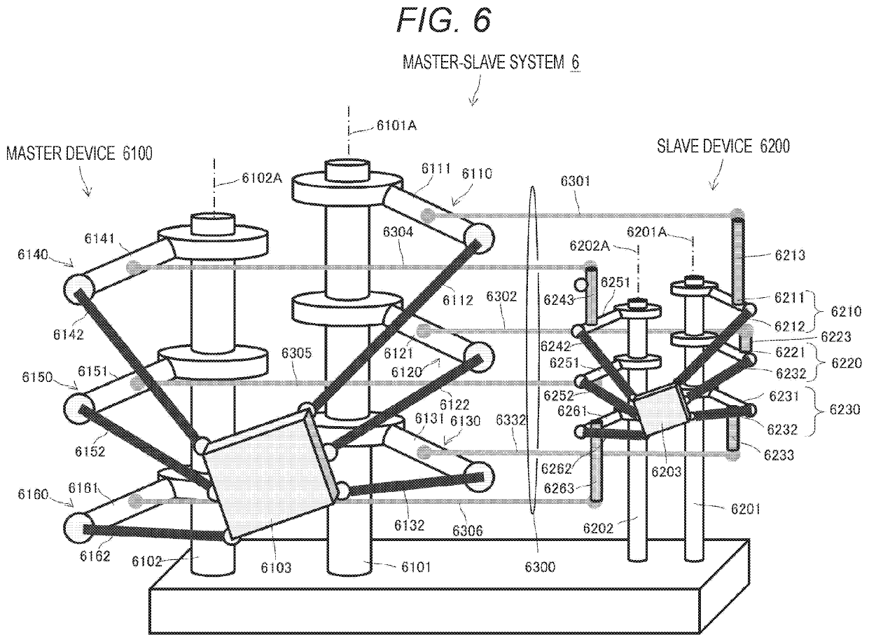

FIG. 6 illustrates a master-slave system 6 to which still other parallel link structures are applied. The master-slave system 6 includes a master device 6100 having a parallel link structure, a slave device 6200 having a parallel link structure similar to that of the master device 6100, and a connecting portion 6300 that mechanically connects the corresponding links of the master device 6100 and the slave device 6200. Hereinafter, description will be made with reference to FIG. 6.

The parallel link structure of the master device 6100 and the parallel link structure of the slave device 6200 are similar. In FIG. 6, the parallel link structure of the master device 6100 is illustrated larger and the parallel link structure of the slave device 6200 is illustrated smaller. However, a size relationship therebetween may be reversed. That is, the parallel link structure of the slave device 6200 may be larger than the parallel link structure of the master device 6100.

The parallel link of the master device 6100 includes two fixed portions 6101 and 6102 having common axes 6101A and 6102A parallel to each other, respectively. In addition, each of the one ends (proximal ends) of three link portions 6110, 6120, and 6130 is supported by one fixed portion 6101 so as to be rotatable about the common axis 6101A. Further, each of the one ends (proximal ends) of three link portions 6140, 6150, and 6160 is supported by the other fixed portion 6102 so as to be rotatable about the common axis 6102A. However, the parallel link structure can be formed by appropriately changing the number of link portions attached to each of the fixed portions 6101 and 6102.

The link portion 6110 includes a drive link 6111 connected to the fixed portion 6101 and a driven link 6112 rotatably connected in series to the other end of the drive link 6111 via a joint. The other link portions 6120 and 6130 connected to the fixed portion 6101 are similarly formed. Each of the drive links 6111, 6121, and 6131 is a freely rotatable link having one degree of freedom about the common axis 6101A. Further, each of the driven links 6112, 6122, and 6132 has two degrees of freedom, that is, a rotational degree of freedom about a rotational axis in a longitudinal direction of each of the drive links 6111, 6121, and 6131 and a rotational degree of freedom about a rotational axis orthogonal to the longitudinal direction. Therefore, each of the link portions 6110, 6120, and 6130 has at least three degrees of freedom. Each of the link portions 6110, 6120, and 6130 may have four or more degrees of freedom.

Further, the link portion 6140 includes a drive link 6141 connected to the fixed portion 6102 and a driven link 6142 rotatably connected in series to the other end of the drive link 6141 via a joint. The other link portions 6150 and 6160 connected to the fixed portion 6102 are similarly formed. Each of the drive links 6141, 6151, and 6161 is a freely rotatable link having one degree of freedom about the common axis 6102A. Further, each of the driven links 6142, 6152, and 6162 has two degrees of freedom, that is, a rotational degree of freedom about a rotational axis in a longitudinal direction of each of the drive links 6141, 6151, and 6161 and a rotational degree of freedom about a rotational axis orthogonal to the longitudinal direction. Therefore, each of the link portions 6140, 6150, and 6160 has at least three degrees of freedom. Each of the link portions 6140, 6150, and 6160 may have four or more degrees of freedom.

In addition, a movable portion 6103 is supported by the other end (distal end) of each of the driven links 6112, . . . , and 6162 of the link portions 6110, . . . , and 6160.

Intervals in the longitudinal (common axis 6101A) direction in which the link portions 6110, 6120, and 6130 are attached to the fixed portion 6101 are arbitrary, and intervals in the longitudinal (common axis 6102A) direction in which the link portions 6140, 6150, and 6160 are attached to the fixed portion 6102 are also arbitrary. Further, the number of link portions attached to each of the fixed portions 6101 and 6102 is not limited to three in FIG. 6, and four or more link portions may be provided. Alternatively, the number of link portions attached may be different between the fixed portions 6101 and 6102. However, the master device 4100 and the slave device 4200 are similar, and both have the same number of link portions.

For example, when the operator of the master device 6100 moves the movable portion 6103 relative to the fixed portions 6101 and 6102 in the three-dimensional space, the driven links 6112, . . . , and 6162 of the respective link portions 6110, . . . , and 6160 rotate with respect to the drive links 6111, . . . , and 6161, and the drive links 6111, . . . , and 6161 rotate about the common axes 6101A and 6102A. Alternatively, when the drive links 6111, . . . , and 6161 of the respective link portions 6110, . . . , and 6160 are rotatably driven about the common axes 6101A and 6102A by respective actuators, the movable portion 6103 can be moved relative to the fixed portions 6101 and 6102 in the three-dimensional space. A user interface (not illustrated) used by the operator for input is mounted on the movable portion 6103.

The parallel link structure of the slave device 6200 is similar to the parallel link structure of the master device 6100. The parallel link of the slave device 6200 includes two fixed portions 6201 and 6202 having common axes 6201A and 6202A parallel to each other, respectively. In addition, one ends (proximal ends) of three link portions 6210, 6220, and 6230 are supported by one fixed portion 6101 so as to be rotatable about the common axis 6201A. Further, one ends (proximal ends) of three link portions 6240, 6250, and 6260 are supported by the other fixed portion 6202 so as to be rotatable about the common axis 6202A.

The link portion 6210 includes a drive link 6211 connected to the fixed portion 6201 and a driven link 6212 rotatably connected in series to the other end of the drive link 6211 via a joint. The other link portions 6220 and 6230 connected to the fixed portion 6201 are similarly formed. Each of the drive links 6211, 6221, and 6231 is a freely rotatable link having one degree of freedom about the common axis 6202A. Further, each of the driven links 6212, 6222, and 6232 has two degrees of freedom, that is, a rotational degree of freedom about a rotational axis in a longitudinal direction of each of the drive links 6211, 6221, and 6231 and a rotational degree of freedom about a rotational axis orthogonal to the longitudinal direction. Therefore, as in the master device 6100, each of the link portions 6210, 6220, and 6230 has at least three degrees of freedom. Each of the link portions 6210, 6220, and 6230 may have four or more degrees of freedom.

Further, the link portion 6240 includes a drive link 6241 connected to the fixed portion 6202 and a driven link 6242 rotatably connected in series to the other end of the drive link 6241 via a joint. The other link portions 6250 and 6260 connected to the fixed portion 6202 are similarly formed. Each of the drive links 6241, 6251, and 6261 is a freely rotatable link having one degree of freedom about the common axis 6202A. Further, each of the driven links 6242, 6252, and 6262 has two degrees of freedom, that is, a rotational degree of freedom about a rotational axis in a longitudinal direction of each of the drive links 6241, 6251, and 6261 and a rotational degree of freedom about a rotational axis orthogonal to the longitudinal direction. Therefore, as in the master device 6100, each of the link portions 6240, 6250, and 6260 has at least three degrees of freedom. Each of the link portions 6240, 6250, and 6260 may have four or more degrees of freedom.

Intervals in the longitudinal (common axis 6201A) direction in which the link portions 6210, 6220, and 6230 are attached to the fixed portion 6201 and intervals in the longitudinal (common axis 6202A) direction in which the link portions 6240, 6250, and 6260 are attached to the fixed portion 6202 correspond to the intervals in the master device 6100. In addition, a movable portion 6203 is supported by the other end (distal end) of each of the driven links 6212, 6222, 6232, 6242, 6252, and 6262.

The link portion 6110 of the master device 6100 and the corresponding link portion 6210 of the slave device 6200 are mechanically connected by the connecting link 6301 included in the connecting portion 6300, and the link portion 6110 and the link portion 6210 operate so as to have the same angle with respect to the common axes 6101A and 6201A, respectively.

Herein, the common axis 6101A of the master device 6100 and the common axis 6201A of the slave device 6200 are arranged in parallel, and relative positions thereof are fixed. In addition, the drive link 6111 of the link portion 6110 and the drive link 6211 of the link portion 6210 are connected by the connecting link 6301 to form a four-bar linkage in which connection between the common axis 6101A and the common axis 6201A serves as the “fixed link”, the connecting link 6301 serves as the “coupler link” that is parallel to the fixed link, the drive link 6111 serves as the “driver link”, and the drive link 6211 serves as the “follower link”. Thus, when the drive link 6111 swings about the common axis 6101A, the other drive link 6211 also swings about the common axis 6201A by the same angle.

Further, similarly, the other link portions 6120 and 6130 attached to the fixed portion 6101 of the master device 6100 and the corresponding link portions 6220 and 6230 attached to the fixed portion 6201 of the slave device 6200 are mechanically connected by other connecting links 6302 and 6303 included in the connecting portion 6300 to form respective four-bar linkages. The link portions 6120 and 6220 operate so as to have the same angle with respect to the common axes 6101A and 6201A, and the link portions 6130 and 6230 operate so as to have the same angle with respect to the common axes 6101A and 6201A. Note that the connecting links 6301 to 6303 have high rigidity and transmit operation between the master device 6100 and the slave device 6200 without delay by using force generated by a constraint condition caused by a mechanical structure. However, in a case where the master device 6100 remotely controls the slave device 6200 or in other cases, wire tension, air pressure, water pressure, or the like is also assumed to be used to transmit operation, instead of the mechanical connecting links 6301 to 6303.

Furthermore, similarly, the link portions 6140, 6150, and 6160 attached to the fixed portion 6102 of the master device 6100 and the corresponding link portions 6240, 6250, and 6260 attached to the fixed portion 6202 of the slave device 6200 are mechanically connected by other connecting links 6304, 6305, and 6306 included in the connecting portion 6300 so as to form a four-bar linkage so that the link portions have the same angle with respect to the common axes 6102A and 6202A. Note that the connecting links 6304 to 6306 have high rigidity and transmit operation between the master device 6100 and the slave device 6200 without delay by using force generated by a constraint condition caused by a mechanical structure. However, in a case where the master device 6100 remotely controls the slave device 6200 or in other cases, wire tension, air pressure, water pressure, or the like is also assumed to be used to transmit operation, instead of the mechanical connecting links 6304 to 6306.

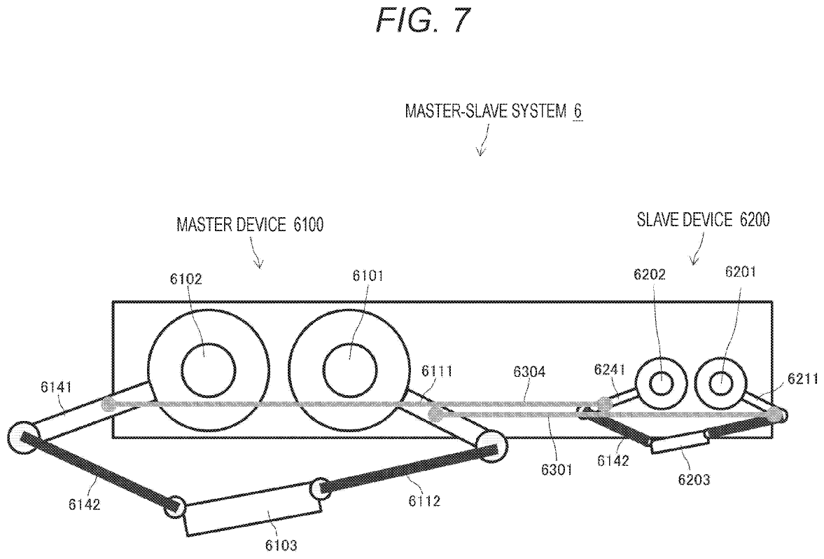

FIG. 7 illustrates a state in which the master-slave system 6 is viewed from above. It should be understood that each of the link portions 6110, . . . of the master device 6100 and each of the corresponding link portions 6210, . . . of the slave device 6200 are connected by the connecting links 6301, . . . to form each four-bar linkage. Hereinafter, description will be made with reference to FIGS. 6 and 7.

In the parallel link structures illustrated in FIGS. 6 and 7, a plurality of link portions is divided into two groups and each link portion in the same group is rotatably supported about their common axis provided in each group, unlike a parallel link structure in which one end (proximal end) of each link portion is arranged on a plane surface, such as the delta-type parallel link. In other words, the rotational axes of the respective link portions in each group pass through the same point. Thus, the corresponding link portions of the master device 6100 and the slave device 6200 that are similar to each other are connected by the connecting link 6300 to form a four-bar linkage and are therefore easily constrained at the same angle. For example, the four-bar linkage can be easily incorporated and the number of link portions can be easily increased, without making improvements such as forming the link portions into a crank shape as in the configuration example of FIG. 3.

Note that, because the master device 6100 and the slave device 6200 are similar, vertical positions of the corresponding link portions may not match in some cases. When the link portions whose vertical positions do not match are connected by connecting links 6301 to 6306, differences between vertical positions of the link portions 6110 and 6210, 6120 and 6220, 6130 and 6230, 6140 and 6240, and 6160 and 6260 may be interpolated by connecting the link portions via spacers 6213, 6223, 6233, 6243, and 6263.

When the operator of the master device 6100 moves the movable portion 6103 relative to the fixed portions 6101 and 6102 in the three-dimensional space, the driven links 6112, . . . , and 6162 of the respective link portions 6110, . . . , and 6160 rotate with respect to the drive links 6111, . . . , and 6161, respectively, and the drive links 6111, . . . , and 6161 rotate about the common axis 6101A or 6102A. Meanwhile, in the slave device 6200, the drive links 6211, . . . , and 6261 of the respective link portions 6210, . . . , and 6250 are constrained by the above four-bar linkage, and rotatably operate about the common axis 6201A or 6202A so as to have the same angles as those of the drive links 6111, . . . , and 6161 of the master device 6100, respectively. Further, the driven links 6212, . . . , and 6262 operate following the drive links 6211, . . . , and 6261, respectively, and the movable portion 6203 moves relative to the fixed portions 6201 and 6202 in the three-dimensional space. A medical instrument such as, forceps (described above), for example, is mounted on the movable portion 6203.

In the master device 6100, the link portions 6110, . . . , and 6160 are arranged on the fixed portion 6101 or 6102 at vertically shifted positions, and, correspondingly, also in the slave device 6200, the link portions 6210, . . . , and 6260 are arranged on the fixed portion 6201 or 6262 at vertically shifted positions. Thus, the four-bar linkages do not collide with each other while the movable portions 6103 and 6203 are being moved in the three-dimensional space as described above.

Because the corresponding link portions of the master device 6100 and the slave device 6200 are constrained at the same angle by the four-bar linkage, operation of the movable portion 6203 with respect to the fixed portions 6201 and 6202 in the slave device 6200 is similar to operation of the movable portion 6103 with respect to the fixed portions 6101 and 6102 in the master device 6100. When a scale of the slave device 6200 is increased with respect to the master device 6100, large operation in the master device 6100 can be converted into smaller operation, and the smaller operation can be reproduced in the slave device 6200. For example, when the slave device 6200 formed at the scale of 1/N of the master device 6100 is connected by a four-bar linkage, operation of the master device 6100 by the operator can be reproduced in the slave device 6200 with a 1/N movement.

When the parallel link is applied to the master device 6100 and the slave device 6200, it is possible to form lightweight tips (the movable portions 6102 and 6202) and make inertia small during operation. Further, three or more degrees of freedom can be easily realized only by connecting the corresponding link portions of the master device 6100 and the slave device 6200 on the proximal end side by a four-bar linkage. Further, when a parallel link structure in which a plurality of link portions is divided into two groups and each link portion in the same group has a rotational degree of freedom about their common axis provided in each group is applied instead of the delta-type parallel link, it is possible to form a four-bar linkage by using ball bearings having a simple configuration and less backlash instead of spherical joints.

Note that the reason why a four-bar linkage is formed by movable links on the proximal end side of the corresponding link portions instead of driven links on the distal end side thereof is that the corresponding links on the distal end side are not parallel to each other in many cases and the four-bar linkage having simple configuration and less backlash cannot be used.

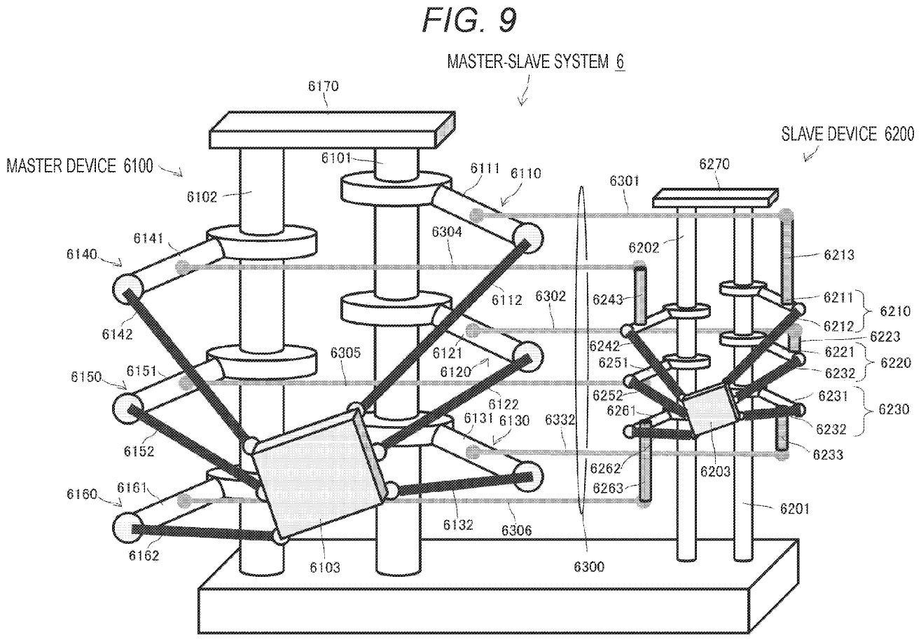

FIG. 9 illustrates a modification example of the master-slave system 6 of FIG. 6. Hereinafter, description will be made with reference to FIG. 9. In the master device 6100 of FIG. 9, a top plate 6170 is attached to upper ends of the two fixed portions 6101 and 6102, thereby improving mechanical strength. Therefore, it is possible to prevent the common axis 6101A serving as the rotational axis of the drive links 6111, 6121, and 6131 and the common axis 6102A serving as the rotational axis of the drive links 6141, 6151, and 6161 from tilting and bending, thereby contributing to precise operation.

Similarly, in the slave device 6200 of FIG. 9, a top plate 6270 is attached to upper ends of the two fixed portions 6201 and 6202, thereby improving mechanical strength. Therefore, it is possible to prevent the common axis 6201A serving as the rotational axis of the drive links 6211, 6221, and 6231 and the common axis 6202A serving as the rotational axis of the drive links 6241, 6251, and 6261 from tilting and bending, thereby contributing to precise operation.

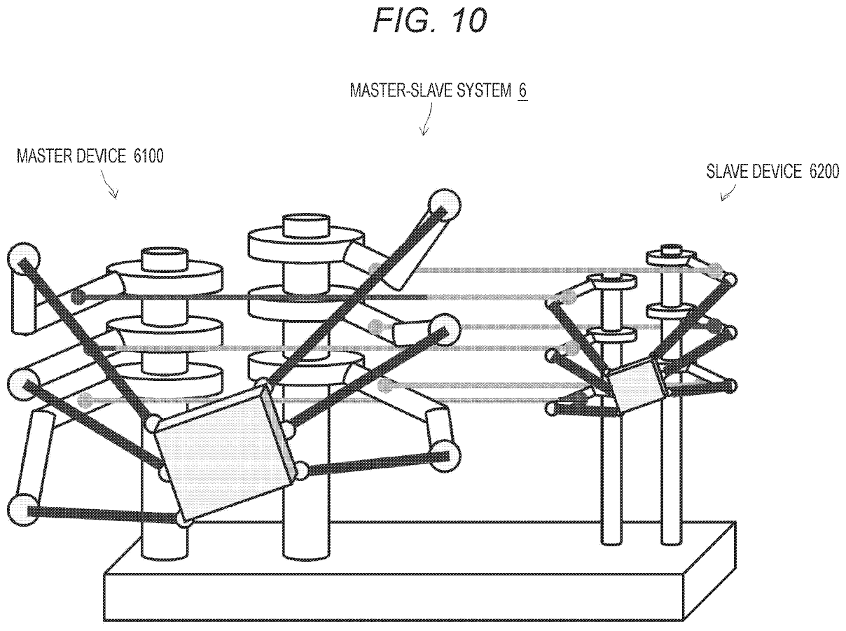

Further, FIG. 10 illustrates another modification example of the master-slave system 6 of FIG. 6. Hereinafter, description will be made with reference to FIG. 10. The master device 6100 and the slave device 6200 of FIG. 10 are not similar in shape, but are mechanically similar. At the expense of similarity in shape, the vertical positions of the corresponding link portions between the master device 6100 and the slave device 6200 can be aligned. Therefore, unlike the example of FIG. 6, the spacers are not required when the corresponding link portions are connected by the connecting links. As a result, mechanical strength can be improved.

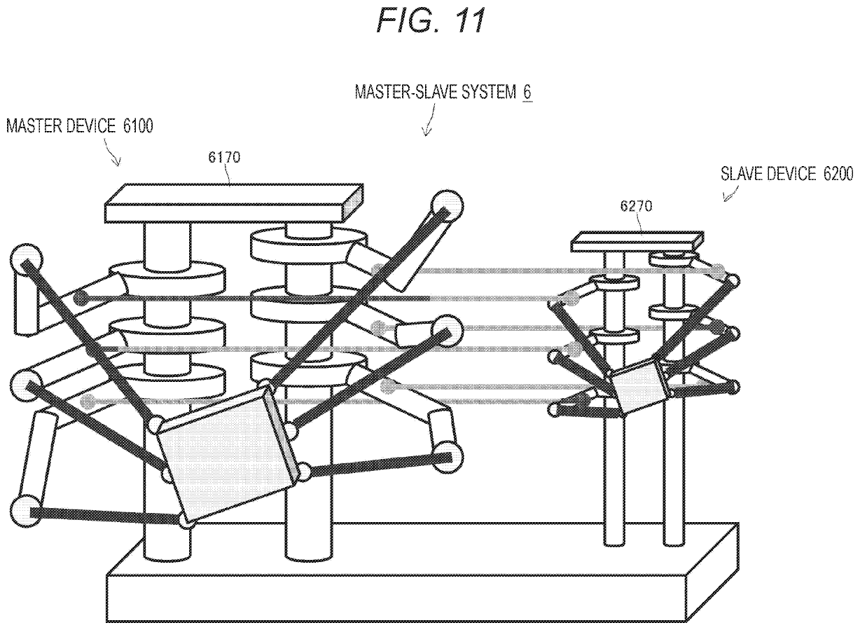

Further, FIG. 11 illustrates a modification example of the master-slave system 6 of FIG. 10. Hereinafter, description will be made with reference to FIG. 11. In both the master device 6100 and the slave device 6200 of FIG. 11, the top plates 6170 and 6270 are attached to the upper ends of two fixed portions, respectively, thereby improving mechanical strength. Therefore, it is possible to prevent the common axes serving as the rotational axes of the drive links from tilting and bending when the master device 6100 and the slave device 6200 are operated, thereby contributing to precise operation.

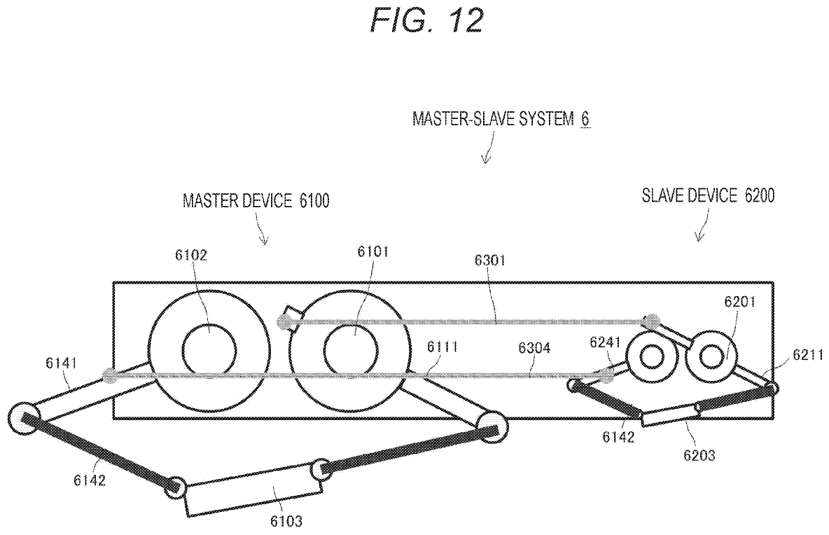

Further, FIG. 12 illustrates a state in which a modification example of the master-slave system 6 of FIGS. 6 and 7 is viewed from above. Hereinafter, description will be made with reference to FIG. 12. Both the master device 6100 and the slave device 6200 include a parallel link including a plurality of link portions having a rotational degree of freedom about a common axis, and the parallel links thereof are similar. In addition, the corresponding link portions 6110 and 6210 that is part of the master device 6100 and the slave device 6200 are connected by the connecting ring 6301 on a back side of the master-slave system 6 (or on a side opposite to a side of the movable portions 6102 and 6202). Part of the four-bar linkage that constrains the corresponding link portions to operate at the same angle is arranged on the back side of the master-slave system 6. In such a case, the four-bar linkages are dispersively arranged. This makes it possible to avoid interference between the four-bar linkages.

Meanwhile, FIGS. 6 to 11 illustrate examples of the master-slave system 6 in which a parallel link structure including a plurality of link portions having a rotational degree of freedom about a common axis is applied to each of the two common axes. In each example, the connecting links that connect similar parallel links provided in the master device 6100 and the slave device 6200, respectively, are incorporated on a front side of the master-slave system 6 (or on the same side as the side of the movable portions 6102 and 6202). In other words, all four-bar linkages that constrain the corresponding link portions to operate at the same angle are arranged on the front side of the master device 6100 and the slave device 6200. In such a case, interference between the four-bar linkages is concerned, and only the front structure has complicated appearance.

The master-slave system disclosed in this specification is formed so that the corresponding links of the master device and the slave device having similar parallel link structures are mechanically connected to operate at the same angle. Therefore, for example, when the size ratio between the master device and the slave device is set to N:1 (where N>1), work performed in the master device by the operator can be transmitted to the slave device only with a mechanical structure and be reproduced as 1/N similar fine work.

In addition, because operation is transmitted between the master device and the slave device only with the mechanical structure, the following effects (1) to (10) can be obtained.

(1) It is possible to avoid and suppress unstable operation and risks caused by electrical or control factors, such as abnormality or breakage of a sensor element such as a force sensor, which is safe.

(2) It is easy to change the magnification of displacement and force between the master device and the slave device.

(3) There is no propagation delay when operation is transmitted between the master device and the slave device.

(4) It is possible to realize accurate fine work because there is no vibration caused by the actuators or no noise of the force sensor.

(5) There is no influence of a power failure because no electric element is included in transmission mechanisms of the master device and the slave device.

(6) There are few entities that are difficult to model, such as wiring layout.

(7) Parameter tuning caused by the structure is unnecessary, and maintenance is easy.

(8) It is easy to carry the master-slave system because there are no cables.

(9) The master-slave system can be tolerant to use in special environments and sterilization because no electronic components are included therein.

(10) It is possible to securely touch hard and soft things without vibration.

When the size ratio between the master device and the slave device is set to N:1 (where N>1), work performed in the master device by the operator can be transmitted to the slave device only with a mechanical structure and be reproduced as 1/N similar fine work. For example, the operator can perform fine work by operating the movable portion of the master device while observing an enlarged video image of the vicinity of the movable portion of the slave device.

Herein, human hands inevitably tremble slightly. It is extremely important to suppress vibration during fine work, and, in particular, it is important to mechanically suppress vibration. In the master-slave system formed by mechanically connecting the similar parallel link structures, vibration can be effectively suppressed by, for example, arranging an attenuator in at least one of the link portions of the parallel link of the master device.

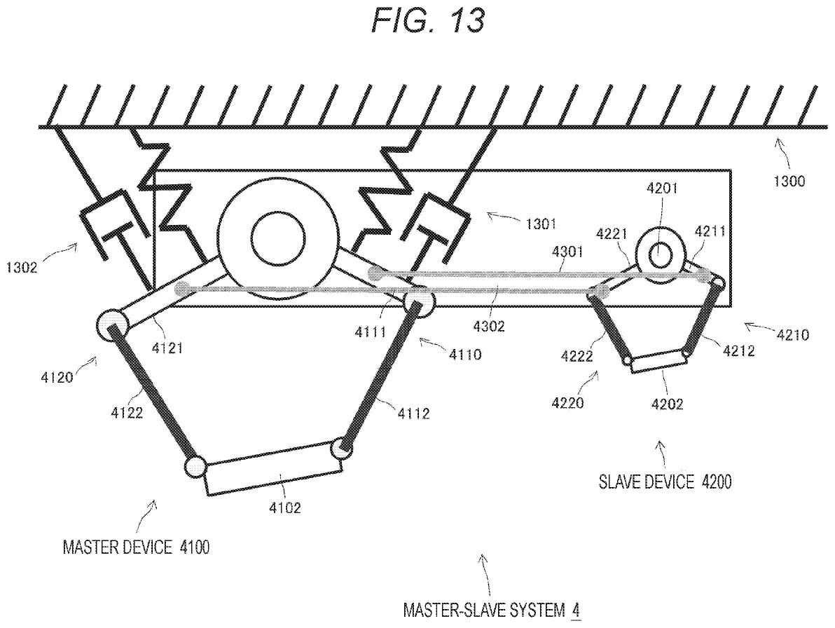

FIG. 13 illustrates an example in which attenuators are arranged in the master device 4100 of the master-slave system 4 of FIG. 5. Hereinafter, description will be made with reference to FIG. 13. Specifically, the proximal end side (drive link 4111) of the link portion 4110 and the proximal end side (drive link 4121) of the link portion 4120 of the parallel link of the master device 4100 each are connected to a wall surface 1300 on the back side by attenuators 1301 and 1302 including a spring, a damper, and the like. Supporting the link portion by using the spring enables self-weight compensation. Further, the use of the damper can reduce an influence of hand trembling.

As a matter of course, it is also possible to obtain a certain effect for suppressing vibration by arranging the attenuators in the parallel link of the slave device 4200 instead of the master device 4100. However, it is considered that arranging the attenuators in the master device 4100 having a larger size is easier in terms of design.

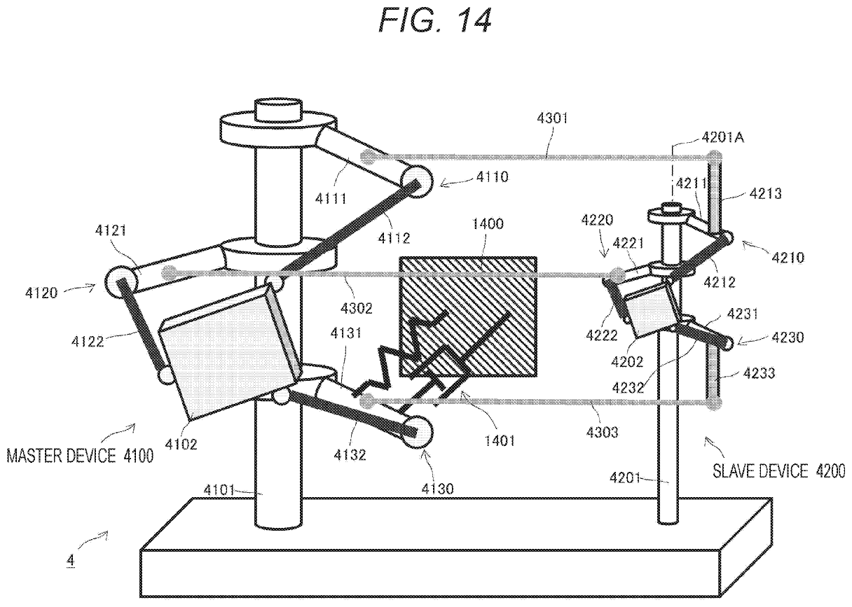

Further, FIG. 14 illustrates an example in which an attenuator is arranged in the master device 4100 of the master-slave system 4 of FIG. 4. Hereinafter, description will be made with reference to FIG. 14. Specifically, the proximal end side (drive link 4131) of the link portion 4130 of the parallel link of the master device 4100 is connected to a back wall surface 1400 by an attenuator 1401 including a spring, a damper, and the like. Force for compensating its own weight is generated by pushing the drive link 4131 toward the front of the device. The configuration of FIG. 14 can also achieve gravity compensation and self-weight compensation because restoring force exerted by the spring acts on the link portion 4130 in a direction opposite to the gravity.

As a matter of course, it is also possible to obtain a certain effect for suppressing vibration by arranging the attenuators in the parallel link of the slave device 4200 instead of the master device 4100. However, it is considered that arranging the attenuators in the master device 4100 having a larger size is easier in terms of design.

Hereinabove, there has been described a method of, in the master-slave system, reproducing work performed in the master device by the operator as 1/N similar fine work in the slave device. Further, it is necessary to further provide a force feedback mechanism in order to realize bilateral control.

However, it is generally known that, according to the principle of leverage, force becomes 1/N when displacement is increased by N times. Meanwhile, the master-slave system proposed in this specification realizes 1/N minute displacement by using a parallel link whose size is 1/N of that of the master device in the slave device. Therefore, it is difficult in a single structure to feed back external force acting on a tip (end effector) of the slave device to the master device with force of M times while reducing displacement in the master device to 1/N in the slave device (where N, M>1).

In view of this, the following description proposes realizing a mechanical bilateral control system by further providing a mechanical feedback mechanism that amplifies the external force acting on the tip of the slave device and feeds back the external force to the master device in the master-slave system (described above) that reduces displacement of the master device to 1/N in the slave device.

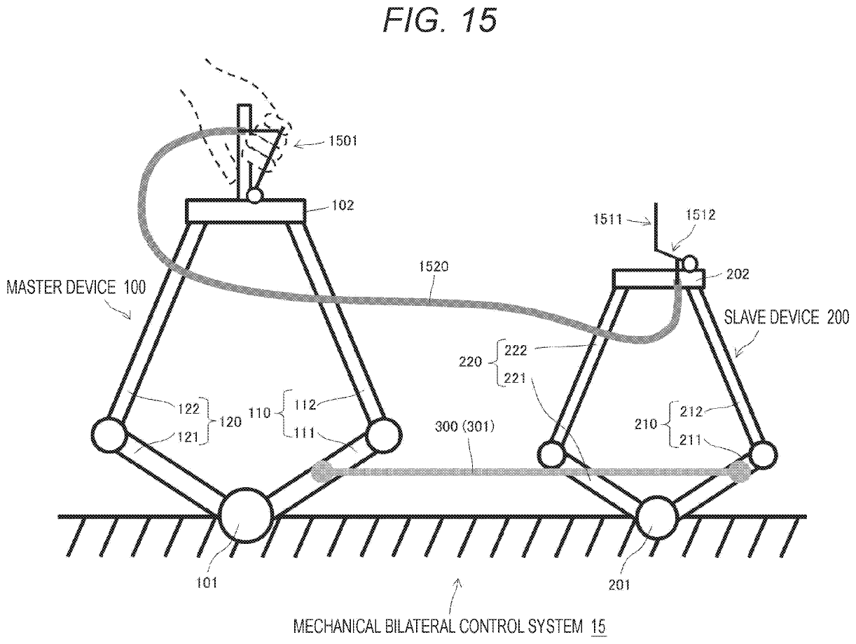

FIG. 15 illustrates a configuration example of a mechanical bilateral control system 15 that is formed by providing, in the master-slave system 1 of FIG. 1, a mechanical feedback mechanism that amplifies the external force acting on the tip of the slave device 200 and feeds back the external force to the master device 100. Hereinafter, description will be made with reference to FIG. 15. Note that a mechanism for reducing displacement in the master device 100 to 1/N in the slave device 200 in the master-slave system 1 has already been described. Thus, description thereof will be omitted.

A probe 1511 for detecting vertical contact force is provided at an end of a leverage 1512 on the movable portion 202 of the slave device 200. The probe 1511 and the leverage 1512 correspond to an instrument for output. Herein, the leverage 1512 has an end to which the probe 1511 is attached as a point of effort and the other end as a fulcrum. In addition, a position that is 1/M of a distance from the point of effort on the fulcrum side of the leverage 1512 is set as a point of load. Therefore, force that is M times as large as the vertical contact force applied to the probe 1511 can be obtained at the point of load.

Further, a lever 1501 serving as a user interface is attached to the movable portion 102 of the master device 100. The lever 1501 can be opened and closed, and can present contact force acting on the tip of the slave device 200 to the operator as gripping force. In addition, when the point of load of the leverage 1512 and the lever 1501 are connected by a mechanical force transmission mechanism 1520, it is possible to feed back the contact force acting on the tip of the slave device 200 to the operator as gripping force amplified by M times.

The mechanical force transmission mechanism 1520 may be a mechanical component in which a wire is smoothly inserted through a hollow tube (sleeve) such as a release of a camera, for example. One end of the wire abuts against the point of load of the leverage 1512. In addition, when the force that is M times as large as the contact force applied to the probe 1511 is transmitted to the other end of the wire via the sleeve to open or close the lever 1501, it is possible to feed back force that is M times as large as the contact force to the operator. The lever 1501 is opened and closed with the contact force expanded by the principle of leverage, and thus the operator can receive small force applied to the tip of the slave device 200 as large force that the operator can easily feel.

Note that FIG. 15 illustrates an example of force feedback having one degree of freedom. However, it is also possible to easily configure force feedback having a plurality of degrees of freedom. Further, if a gripping structure such as tweezers (or forceps) is provided at the tip of the slave device 200, it is also possible to feed back gripping force.

Hereinabove, there have been described several examples of the master-slave system formed so that corresponding links of the master device and the slave device each having similar parallel link structures are connected only by a mechanical structure to operate at the same angle.

As a matter of course, it is also possible to incorporate electrical components in the master-slave system of this kind.

For example, it is possible to record adjustment of force during work by providing a force sensor including a strain gauge and the like in at least one of the structure of the master device, the structure of the slave device, or the structure of the connecting portion.

Further, it is possible to perform self-weight compensation control and record and reproduce operation of the parallel link by providing an encoder for measuring a rotation angle of a driving motor and link in the parallel link of one of the master device and the slave device.

The master-slave system disclosed in this specification basically does not require electric wiring. However, multiaxial external force acting on the tip portion of the slave device may be fed back to the master device. Further, a vibration transmission mechanism for feeding back vibration generated in the slave device to the master device may be provided by providing a sensor in the slave device and providing an actuator in the master device. Further, a stethoscope may be attached to the slave device to collect sound in a work environment. Further, a microphone or an acceleration sensor may be attached to the slave device to pick up and amplify sound in a work place and present the sound to the master device.

### INDUSTRIAL APPLICABILITY

As described above, the technology disclosed herein has been described in detail with reference to specific embodiments. However, it is obvious that those skilled in the art can make modifications and substitutions of the embodiments, without departing from the scope of the technology disclosed herein.

The parallel link structures disclosed in the specification and drawings of the present application are merely examples. The technology disclosed in this specification is also applicable to a master-slave system adopting various other types of parallel link structures. Further, the parallel link structures to be adopted may be variously installed, such as being placed on a floor, hung on a wall, hung from a ceiling, or placed on a shelf.

The master-slave system based on the technology disclosed in this specification is applicable to a fine working apparatus that performs work on, for example, a small target object such as a cell. As a matter of course, the technology disclosed in this specification is applicable to the medical field and other various industrial fields.

In short, although the technology disclosed herein has been described by using examples, the content of description herein should not be interpreted in a limited manner. The claims should be taken into consideration in order to determine the gist of the technology disclosed herein.

Note that the technology disclosed in this specification can also be configured as follows.

(1) A master-slave system including:

a master device having a first link structure;

a slave device having a second link structure similar to the first link structure; and

a connecting portion that mechanically connects corresponding links of the first link structure and the second link structure so that the corresponding links have the same angle.

(2) The master-slave system according to (1), in which

the connecting portion uses one of a link, wire, air pressure, or water pressure.

(3) The master-slave system according to (1) or (2), in which

the first link structure and the second link structure include respective similar parallel links.

(4) The master-slave system according to any one of (1) to (3), in which

the first link structure and the second link structure include respective similar parallel links, and

the connecting portion connects the corresponding links provided at proximal ends of the first link structure and the second link structure so as to form a four-bar linkage.

(5) The master-slave system according to any one of (1) to (4), in which

the first link structure and the second link structure include similar delta-type parallel links, respectively.

(6) The master-slave system according to (5), in which

a rotational axis of each link provided at a proximal end of the delta-type parallel link passes through the same point.

(7) The master-slave system according to any one of (1) to (4), in which

the first link structure and the second link structure include respective similar parallel links, each of the parallel links including a plurality of links having a rotational degree of freedom about a fixed common axis.

(8) The master-slave system according to any one of (1) to (7), in which

a user interface used for input is provided at a tip of the first link structure, and

an instrument used for output is provided at a tip of the second link structure.

(9) The master-slave system according to any one of (1) to (8), in which

an external force detection unit that receives external force and an amplification unit that amplifies the external force are provided at a tip of the second link structure,

a presentation unit that presents force is provided at a tip of the first link structure, and

a transmission unit that transmits the external force amplified by the amplification unit to the presentation unit is provided.

(10) The master-slave system according to (9), in which

the amplification unit amplifies the external force by using the principle of leverage.

(11) The master-slave system according to any one of (1) to (10), further including

a spring for self-weight compensation, the spring being attached to at least one of the links included in the first link structure or the second link structure.

(12) The master-slave system according to any one of (1) to (11), further including

a damper that reduces vibration, the damper being attached to at least one of the links included in the first link structure or the second link structure.

(13) The master-slave system according to any one of (1) to (12), in which

the first link structure and the second link structure are link structures having at least three or more degrees of freedom.

(14) The master-slave system according to any one of (1) to (12), in which

the first link structure and the second link structure are link structures having at least four or more degrees of freedom.

(15) An operation apparatus for operating a robot apparatus, the operation apparatus including:

a first link structure; and

a connecting portion that mechanically connects corresponding links of a second link structure similar to the first link structure so that the corresponding links have the same angle, the second link structure being included in the robot apparatus.

(16) A robot apparatus that operates following operation of an operation apparatus, the robot apparatus including:

a second link structure; and

a connecting portion that mechanically connects corresponding links of a first link structure similar to the second link structure so that the corresponding links have the same angle, the first link structure being included in the operation apparatus.

### REFERENCE SIGNS LIST

1 Master-slave system
100 Master device
101 Fixed portion
102 Movable portion
110, 120 Link portion
111, 121 Drive link
112, 122 Driven link
200 Slave device
201 Fixed portion
202 Movable portion
210, 220 Link portion
211, 221 Drive link
212, 222 Driven link
300 Connecting portion
301 Connecting link
2100 Master device
2110, 2120, 2130 Link portion
2111, 2121, 2131 Rotational axis
2200 Slave device
2210, 2220, 2230 Link portion
2211, 2221, 2231 Rotational axis
2301, 2302, 2303 Connecting link
3100 Master device
3110, 3120, 3130 Link portion
3200 Slave device
3210, 3220, 3230 Link portion
3301, 3302, 3303 Connecting link
4 Master-slave system
4100 Master device
4101 Fixed portion
4102 Movable portion
4110, 4120, 4130 Link portion
4111, 4121, 4131 Drive link
4112, 4122, 4132 Driven link
4200 Slave device
4201 Fixed portion
202 Movable portion
4210, 4220, 4230 Link portion
4111, 4121, 4131 Drive link
4212, 4222, 4232 Driven link
4213, 4233 Spacer
4300 Connecting portion
4301, 4301, 4302 Connecting link
6 Master-slave system
6100 Master device
6101, 6102 Fixed portion
6103 Movable portion
6110, 6120, 6130 Link portion
6140, 6150, 6160 Link portion
6111, 6121, 6131 Drive link
6141, 6151, 6161 Drive link
6112, 6122, 6132 Driven link
6142, 6152, 6162 Driven link
6170 Top plate
6200 Slave device
6201, 6202 Fixed portion
6206 Movable portion
6240, 6250, 6260 Link portion
6211, 6221, 6231 Drive link
6241, 6251, 6261 Drive link
6212, 6222, 6232 Driven link
6242, 6252, 6262 Driven link
6213, 6223, 6233, 6243, 6263 Spacer
6270 Top plate
6300 Connecting portion
6301 to 6306 Connecting link
1301, 1302 Attenuator
1401, 1402 Attenuator
1501 Lever
1511 Probe
1512 Leverage
1520 Force transmission mechanism

1. A master-slave system comprising:
a master device having a first link structure;
a slave device having a second link structure similar to the first link structure; and
a connecting portion that mechanically connects corresponding links of the first link structure and the second link structure so that the corresponding links have the same angle.

2. The master-slave system according to claim 1, wherein
the connecting portion uses one of a link, wire, air pressure, or water pressure.

3. The master-slave system according to claim 1, wherein
the first link structure and the second link structure include respective similar parallel links.

4. The master-slave system according to claim 1, wherein
the first link structure and the second link structure include respective similar parallel links, and
the connecting portion connects the corresponding links provided at proximal ends of the first link structure and the second link structure so as to form a four-bar linkage.

5. The master-slave system according to claim 1, wherein
the first link structure and the second link structure include similar delta-type parallel links, respectively.

6. The master-slave system according to claim 5, wherein
a rotational axis of each link provided at a proximal end of the delta-type parallel link passes through the same point.

7. The master-slave system according to claim 1, wherein
the first link structure and the second link structure include respective similar parallel links, each of the parallel links including a plurality of links having a rotational degree of freedom about a fixed common axis.

8. The master-slave system according to claim 1, wherein
a user interface used for input is provided at a tip of the first link structure, and
an instrument used for output is provided at a tip of the second link structure.

9. The master-slave system according to claim 1, wherein
an external force detection unit that receives external force and an amplification unit that amplifies the external force are provided at a tip of the second link structure,
a presentation unit that presents force is provided at a tip of the first link structure, and
a transmission unit that transmits the external force amplified by the amplification unit to the presentation unit is provided.

10. The master-slave system according to claim 9, wherein
the amplification unit amplifies the external force by using the principle of leverage.

11. The master-slave system according to claim 1, further comprising
a spring for self-weight compensation, the spring being attached to at least one of the links included in the first link structure or the second link structure.

12. The master-slave system according to claim 1, further comprising
a damper that reduces vibration, the damper being attached to at least one of the links included in the first link structure or the second link structure.

13. The master-slave system according to claim 1, wherein
the first link structure and the second link structure are link structures having at least three or more degrees of freedom.

14. The master-slave system according to claim 1, wherein
the first link structure and the second link structure are link structures having at least four or more degrees of freedom.

15. An operation apparatus for operating a robot apparatus, the operation apparatus comprising:
a first link structure; and
a connecting portion that mechanically connects corresponding links of a second link structure similar to the first link structure so that the corresponding links have the same angle, the second link structure being included in the robot apparatus.

16. A robot apparatus that operates following operation of an operation apparatus, the robot apparatus comprising:
a second link structure; and
a connecting portion that mechanically connects corresponding links of a first link structure similar to the second link structure so that the corresponding links have the same angle, the first link structure being included in the operation apparatus.
